(19) United States
(12) Patent Application Publication
(10) Pub. No.: US 2010/0007732 A1
(43) Pub. Date: Jan. 14, 2010

(54) Image, sound, and sensor data capture apparatus embedded into display apparatus

(76) Inventor: Ron Tolmei, Concord, CA (US)

Correspondence Address: Ron Tolmei, Suite 32, 1399 Ygnacio Valley Road, Walnut Creek, CA, 94598, US

(21) Appl. No.: 12/217,787

(22) Filed: Jul. 8, 2008

(51) Int. Cl. H04N 7/18

(52) U.S. Cl. 348/143

(57) ABSTRACT

Although the webcam and microphones have been available for computer systems, beginning sometime before 2000, as separate devices and later embedded into computer housings, there has not been an attempt to embed the technology directly into the display itself. This invention attempts to resolve that issue and relates to image, sound, and sensor data capture apparatuses that are physically embedded directly into the display apparatus—not the housing.

### CROSS-REFERENCE TO RELATED APPLICATIONS

### References Cited

U.S. Patent Documents

| | | | |
|---|---|---|---|
| 4,864,613 | Sep. 5, 1989 | Van Cleave | 380/220. |
| 6,061,604 | May 9, 2000 | Russ, et. al | 700/90. |
| 6,011,579 | Jan. 4, 2000 | Newlin | 348/14.08. |
| 6,070,148 | May 30, 2000 | Mori et al. | 705/26. |
| 4,670,739 | Jun. 2, 1987 | Kelly, Jr. | 340/539. |
| 5,774,825 | Jun. 30, 1998 | Reynolds | 701/207 |
| 6,141,682 | Oct. 31, 2000 | Barker | 709/217 |
| 6,481,013 | Nov. 12, 2002 | Dinwiddie et al. | 348/6 |
| 5,687,499 | Nov. 18, 1997 | Brnjac | 4/524 |
| 7,259,783 | Aug. 21, 2007 | Anderson | 348/222.1 |
| 5,469,020 | Nov. 21, 1995 | Herrick | 313/511 |
| 6,081,420 | Jun. 27, 2000 | Kim, et al. | 361/681 |
| 7,228,061 | Jun. 5, 2007 | Mori, et al. | 386/95 |

### BACKGROUND OF THE INVENTION

1. Field of the Invention

Sometime in the late 1990's video cameras and related software for personal computers began to be available for use—although the means for mass communication of this information was not yet available. This was primarily because broadband communications technology was not readily available to the public—at least for a reasonable cost. However with the coming of broadband and high speed digital subscriber line technology it did not take long before the technology became available for, what we now call webcam, to be in common use.

Although the webcam and microphones have been available for personal computers as separate devices, and lately embedded into computer and display housings, there has not been an attempt to embed the technology directly into the display itself. This invention attempts to resolve that issue and relates to image, sound, and sensor data capture apparatuses that are physically embedded directly into the display apparatus itself—not the housing.

This embedding, via economy of scale, enables hundreds of functions to be performed to gather data, view points or items of interest, leave or forward messages and provide bidirectional communication to mitigate terrorism, child molestation, vandalism, theft, fire and the like. Visual points of interest, areas, or facilities, can be visually and audibly monitored using these embedded low cost commercially available image capture devices, such as charge-coupled devices (CCD) cameras, and microphones with composite video and audio capabilities. Items, areas, or facilities can be observed and audibly monitored on site, or remotely, 24 hours a day 7 days a week by directing the output to a monitor or internet connection. Additionally this can provide law enforcement the eyes and ears of a large viewing audience 24 hours a day 7 days a week with instant reporting of “at risk” events before or as they occur.

The image, sound, and sensor data capture apparatuses can be installed in virtually any device with the preferred device being a television monitor uses existing of-the-shelf technology (COTS) with only minor modifications. Additionally the apparatuses are compatible with, or may be adapted for future use to, commercial bi-directional communication equipment if so desired or pass information to an informational service company. Also, the image, sound, and sensor data capture apparatuses can be supplemented with, or modified to have, low light level, spectral, such as infrared, capabilities to detect heat or movement at any time without modification to other components of the system. Depending on the operational requirements the image, sound, and sensor data capture apparatuses can be programmed to operate only when there is a change in parameters such as the level of sound level, image, or temperature in the field of view.

2. Discussion of Background

In light of the increased activity of theft, terrorism, kidnapping, molestation, and crime in general there is an immediate need to expand surveillance to protect us from these egregious acts. The government has expanded its use of conventional means of protection with the use of electronic security systems and supplemental guards at public facilities like airports, bridges, and such. Unfortunately electronic security systems themselves are not sophisticated enough to replace even an unskilled observer's ability to detect and thwart crimes. Therefore the emphasis has been to provide human guards, with their ability to think and adapt to the situation at hand, as the eyes and ears of law enforcement. This, one pair of eyes and ears, solution however is not a cost-effective way to monitor the thousands of areas and facilities that need to be under surveillance 24 hours a day 7 days week.

There have been many attempts to provide audio and visual surveillance examples of which are shown in the prior art apparatus contained U.S. Pat. No.4,670,739 issued Jun. 2, 1987. Other types of surveillance apparatus are shown in U.S. Pat. No.6,070,148 issued May 30, 2000, U.S. Pat. No.4,864,613 issued Sep. 5, 1989, U.S. Pat. No.6,061,604 issued May 9, 2000, U.S. Pat. No.6,011,579 issued Jan. 4, 2000, U.S. Pat. No.6,141,682, issued Oct. 31, 2000, and U.S. Pat. No.5,774,825, issued Jun. 39, 1998.

Inherent in the design of these systems is the fundamental problem of requiring additional, and unique, external equipment with unique communication protocols and capabilities lending themselves to incompatibility with existing distribution systems. This is because each system must be physically installed on existing equipment and therefore does not guarantee global compatibility. These special purpose systems are designed for unique applications and therefore do not have the capability of mass distribution that is paramount to meet the needs of law enforcement in a timely and cost-effective manner.

The present invention's advantages are that: The production of image, sound, and sensor data capture apparatuses that are physically embedded into display apparatus guarantees global compatibility, flexibility, and low cost for a system that can visually and audibly annunciate issues of concern locally or remotely without the addition of external equipment. Further, and most importantly the system can be modified, via modularity of design as will be presented later, on a site-by-site basis without further development while maintaining compatibility—which is tantamount to society's needs.

### BRIEF SUMMARY OF THE INVENTION

According to the present invention a visual, audible, and sensor specific surveillance system using data capture apparatus embedded directly into a display to provide a cost-effective, self contained and standardized solution to visual, audible, and sensor specific bidirectional communication is disclosed.

The apparatus embedded into the display has image capture capabilities, such as charge coupled device cameras, acoustical microphones and associated parameter specific sensor equipment suitable for detecting, observing and recording 24 hours a day 7 days a week without human intervention. Each set of apparatus is imbedded into the display during manufacturing of the display and can operate independently as a stand-alone system not requiring interaction with the display. Each display monitors the area under surveillance and can, if desired, bidirectionally communicate audio, video, and sensor signals to the display device, remote devices, or remote locations.

In the preferred embodiment of the invention, the image, acoustical, and sensor data capture device, or devices, are located at or near the top, bottom, or sides of the display device to avoid obstructing the images being displayed. However the capture devices can be physically embedded into any area of the display as will become apparent in the detail description to follow. The surveillance system is modular in nature and modules can be housed in the display's equipment area or remotely. Electrical power and support electronics to the system can be supplied from existing display electronics or, alternately, supplied externally. In another embodiment, the entire surveillance system can be supplied as subassemblies functionally equivalent to the preceding self-contained embodiment except it is fabricated in separate assemblies.

Other objects of the present invention will become apparent upon reading the following specification and referring to the accompanying drawings in which similar characters of reference represent corresponding parts in each of the views.

### BRIEF DESCRIPTION OF THE SEVERAL VIEWS OF THE DRAWINGS

The above advantages and subsequent description will be more readily understood by reference to the following drawings.

FIG. 1 is a pictorial showing image, sound, and sensor data capture apparatus embedded directly into display

FIG. 2 is a block diagram showing the embedded components and supporting ancillary modules.

### DETAILED DESCRIPTION OF THE INVENTION

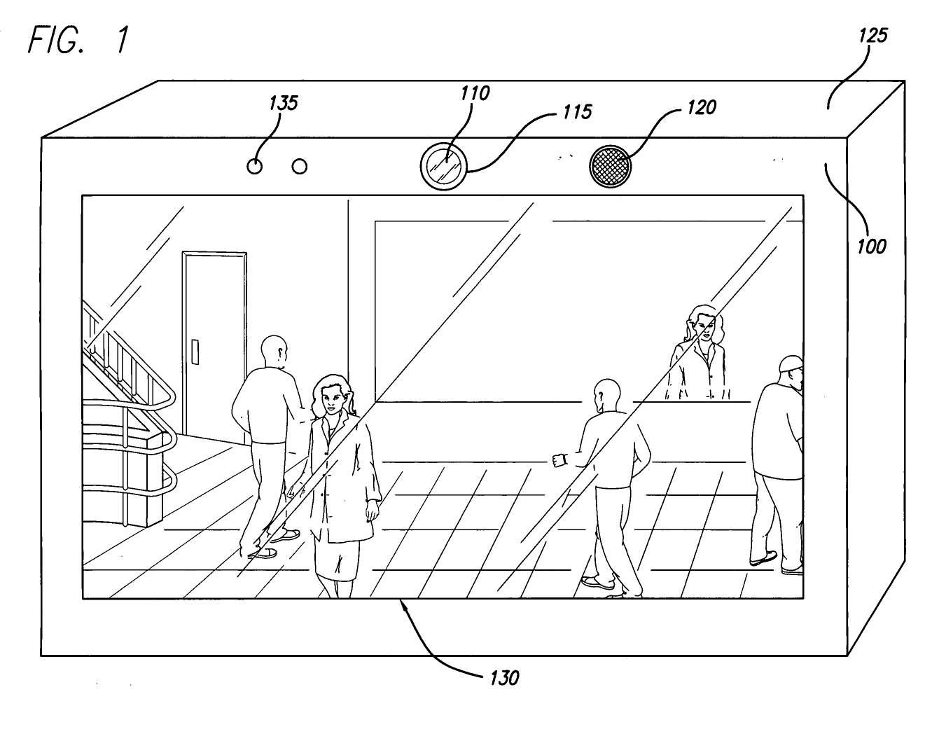

In FIG. 1 Housing for the display 125 is shown, with display 100, sensors 135, image capture apparatus 110 such as a charge coupled device (CCD) or complementary metal oxide semiconductor (CMOS) camera, viewing 130 a store front in a shopping mall, a fixed or variable focus lens 115 that can be part of the glass or plastic overlay normally used to protect the display, and a sound capture apparatus 120 such as a microphone to capture sound information. It being understood that a significant feature of the invention is that the image, audio, and sensor data capture apparatuses that can be embedded in the display are readily available from a multiplicity of manufacturers as commercial off-the-shelf devices.

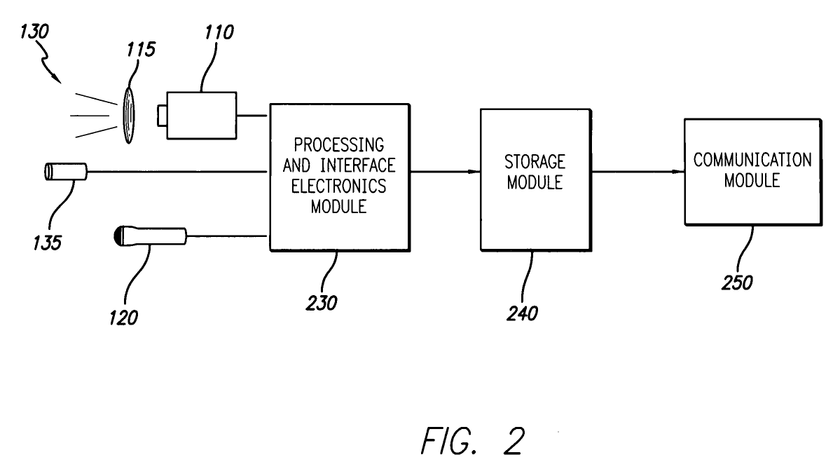

FIG. 2. is a block diagram of the embedded image, sound, and sensor data capture apparatus with ancillary electronics modules that may, or may not, be embedded in the display. 110 is an exemplary image capture apparatus viewing 130 a store front in a shopping mall. A fixed or variable focus lens is depicted as 115 and can be either part of the glass or plastic overlay normally used to protect the display or integral with the image capture apparatus 110. Sensors 135 are depicted as monitoring view 130 while 120, a sound capture apparatus is depicted capturing acoustical information.

230 is an image, sound, and sensor data signal processing module with interface electronics to support ancillary, sensors, touch screen interfaces, analog to digital, or digital to analog converters. 240 is a storage module that houses memory storage devices used to store images, and messages being comprised of solid state memory and disk drive technology. 250 is a bidirectional communication module with support electronics for interfacing with the display, the internet, touch screens, and input/output ports. It being understood that one of the features of the invention is that modules may be internal or external to the display and that the display need not be active for functions of the modules to be operational i.e. a multiplicity of module operations may be performed simultaneously with or without the display being active.

The advantages and uses of an image, sound, and sensor data capture apparatus being embedded into display apparatus and associated modules are described hereafter as:
1. The apparatuses of the invention disclosed are available as Commercially Off-The-Shelf devices (COTS) and therefore do not require further research and development to bring the display to market. Additionally, the image and sound capture devices, via signal a processing module and interface electronics, process the information into composite signals that contain video, audio, and synchronization signals, that can then be viewed on a commercially available television receiver, monitor, stored on a videocassette recorder (VCR), or other recording device. Further, the image, sound, and sensor capture apparatus sensitivity may be chosen to monitor other spectrums of concern, such as infrared to view heat emitting objects.
2. The embedding of the apparatuses into the display itself, and supporting modules, insures uniform compatibility of interface and is cost-effective owing to commercially available off-the-shelf devices and economy of scale—every display regardless of its size or type is plug to plug compatible insuring one size fits all compatibility of form and function.

While the invention has been described in its preferred embodiments it is to be understood that the words which have been used are words of description rather than limitation and that changes may be made within the preview of the appended claims without departing from the true scope and spirit of the invention in its broader aspects.

What is claimed is:

1. A plurality of image, sound, and sensor data capture apparatuses embedded directly into display apparatus itself, as opposed to the display housing, and associated electromechanical modular ancillary equipment whose primary function in combination is surveillance, display, and communication.

2. The apparatus of claim 1 wherein the image capture apparatuses are cameras with various spectral responses, sound capture apparatuses are microphones and sensors are environmental.

3. The apparatus of claim 2 wherein the image capture apparatuses are Charge Coupled Devices, (CCD), or Complementary Metal Oxide Semiconductor (CMOS) cameras with various spectral responses, sound capture apparatuses are acoustical microphones and sensors that are sensitive to the infrared, ultraviolet, or visual spectrum.

4. The apparatus of claim 1 wherein the displays are flat panel displays using liquid crystal, plasma, light emitting diodes, optical light emitting diodes, surface conduction electron emitter, or digital light processing technologies

5. The apparatus of claim 1 wherein the electromechanical modular ancillary equipment is comprised of modules providing connection to the internet or world wide web, signal processing, storage, and communication devices.

6. The apparatus of claim 1 wherein the display has touch screen capability.

7. The apparatus of claim 1 wherein the Image, sound, and sensor data capture apparatus embedded into display or ancillary module apparatus is used for theft, burglary, intrusion, fire, or flood detection.

8. The apparatus of claim 1 wherein the image, sound, and sensor data capture apparatus embedded into the display or ancillary module apparatus are used for displaying messages, gathering and disseminating information, video conferencing, emergency communications, taking and conveying medical information, child monitoring, or gaming.

9. The apparatus of claim 1 wherein the image, sound, and sensor data capture apparatus embedded into display and ancillary module apparatuses are used for local or remote diagnostic imaging.

10. The apparatus of claim 1 wherein the image, sound, and sensor data capture apparatus embedded into the display, and modules, are used to view, hear, and bidirectionally communicate with television broadcasts.
